(19) United States
(12) Patent Application Publication
(10) Pub. No.: US 2009/0282334 A1
(43) Pub. Date: Nov. 12, 2009

(54) System and method for providing information using outside sound recognition of mobile phone, and mobile terminal for the same

(75) Inventor: Chang-Yeop Hwang, Seoul (KR)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Mobilians Co., Ltd., Seoul (KR)

(21) Appl. No.: 11/919,272

(22) PCT Filed: Nov. 29, 2006
(86) PCT No.: PCT/KR2006/005093

§ 371 Date: Oct. 24, 2007

(30) Foreign Application Priority Data
May 4, 2006 (KR) 10-2006-0040612

(51) Int. Cl. G06F 17/00; H04B 1/38; G06F 3/048

(52) U.S. Cl. 715/716; 700/94; 455/566

(57) ABSTRACT

An information providing system using external sound source recognition of a mobile communication terminal includes a sound source recognizing means for receiving a specific sound source in the external environment by playing a sound source file and recognizing sound source information; an intrinsic information detecting means for detecting the intrinsic information inserted when manufacturing the sound source file from the sound source information; an intrinsic information interpreting means for decoding the intrinsic information to interpret the meaning of the intrinsic information; and an intrinsic information managing means for outputting the contents of the intrinsic information on a screen to display the intrinsic information to the user.

### TECHNICAL FIELD

The present invention relates to information providing system and method using external sound source recognition of a mobile communication terminal and the mobile communication terminal therefor, and in particular, to information providing system and method, in which a mobile communication terminal of an user recognizes a specific sound source in the external environment, extracts intrinsic information contained in the sound source, displays the intrinsic information on a screen, and if the intrinsic information is a Uniform Resource Locator (URL) address, guides the user to automatic connection.

### BACKGROUND ART

Digital Rights Management (DRM) technique manages a use authorization of a user to prevent an illegal use of digital contents, and it provides the contents in an encrypted type and an encryption key for decoding encryption of the contents as a license separately from the contents, so that only a justifiable user is authorized to use the contents through the encryption key. The DRM technique covers techniques related to copyrights protection, for example a watermarking technique or a Digital Object Identifier (DOI).

The DRM technique uses encryption so that only a user having a justifiable use authorization is allowed to use the corresponding contents, however, it fails to prevent an illegal use of the contents if the justifiable user captures the pictures using a capture tool, or in the case of audio, stores the audio as digital by analogue reproduction during reproducing the contents.

In order to solve the problem, a solution has been suggested to integrate the DRM technique with a fingerprinting technique. The fingerprinting technique is a kind of watermarking technique. While the watermarking technique inserts copyrights information of an original owner into the contents to such an extent not unpleasant to human perception and identifies and verifies the right of the contents, the fingerprinting technique includes information of a user who possesses the contents as well as the copyrights information based on the watermarking technique, and thus is capable of tracking and identifying a user who has committed illegal copying, thereby protecting the copyrights with more intelligence and activity. That is to say, the fingerprinting technique inserts information in real time at the time that a user, not a server, uses the contents, and thus is advantageously capable of providing a larger amount of information than the watermarking technique. For example, when reproducing the contents at an user terminal by the DRM fingerprinting technique, the fingerprinting technique inserts user information into the reproduced contents in real time, whereby even though illegal copy is made, the fingerprinting technique is capable of identifying user information in the copied contents, thereby tracking an illegal user.

The DRM technique (for example, watermarking or fingerprinting) applied to the above-mentioned information protection requires robustness of insertion that leads to proper detection of the inserted information against data processing, for example compression, noise, format conversion or attack, however, it information is inserted excessively robustly, the efficiency of detection is improved corresponding to robustness, but it appears to insert noises to original data. On the contrary, if information is inserted excessively weakly, it is not unpleasant to human perception, but the efficiency of detection is lowered. Therefore, the limit of robustness is generally set such that the inserted information endures only the change of data, to the extent of not deteriorating the value of the contents against various data processing including conversion, distortion or attack. This is because, in aspect of property protection, the contents having a predetermined level of video quality or audio quality is determined to be protected, whereas the contents having data damaged by noises or attacks beyond a predetermined extent is determined to be not protected. Further, the conventional watermarking or fingerprinting has been developed in a PC-based environment, and thus is capable of utilizing resources (for example, a memory or a processor) of sufficient complexity or performance to some extent.

In practice, however, it is hard to apply the conventional watermarking or fingerprinting technique to techniques for recognizing an external sound source and detecting intrinsic information contained in the sound source by a mobile communication terminal as in the present invention. This is because a resource environment of a mobile communication terminal is poor, compared with the performance of a PC. And, a proper storage method or storage format of a mobile communication terminal has lower quality of data than a typical audio format.

In conclusion, it requires adaptability for environment, performance and interface of a mobile communication terminal, not in application of property protection weighing the value of contents, but in application of information insertion and detection for providing a convenient service to a user through recognition of the sound source played in the external environment.

### DISCLOSURE

### Technical Problem

The present invention is designed to solve the problems of the prior art, and therefore it is an object of the present invention to provide a user with a specific information by inserting intrinsic information to be communicated to an user into an original sound source to generate a sound source file, recognizing the sound source by playing the sound source file through a mobile communication terminal, detecting the inserted intrinsic information, automatically displaying the intrinsic information on a screen of the mobile communication terminal, and automatically executing a linked interface according to data of the intrinsic information.

### Technical Solution

In order to achieve the above-mentioned object, according to an information providing system using recognition of an external sound source by a mobile communication terminal of the present invention, the information providing system in which the mobile communication terminal recognizes a specific sound source in the external environment, detects intrinsic information from sound source information and displays the contents contained in the intrinsic information on a screen to inform an user of the intrinsic information, includes a sound source recognizing means for receiving a specific sound source in the external environment by playing a sound source file and recognizing sound source information; an intrinsic information detecting means for detecting the intrinsic information inserted when manufacturing the sound source file from the sound source information; an intrinsic information interpreting means for decoding the intrinsic information to interpret the meaning of the intrinsic information; and an intrinsic information managing means for outputting the contents of the intrinsic information on the screen to display the intrinsic information to the user.

According to preferred embodiments of the present invention, the sound source recognizing means includes function for receiving an analogue sound source in the external environment by playing the sound source file having the inserted intrinsic information; function for converting the analogue sound source to a digital sound source using a sound codec; and function for storing the digital sound source in an internal memory as the sound source information.

Further, the intrinsic information detecting means includes function for converting the sound source information to pulse code modulated (PCM) wave data; and function for detecting the intrinsic information from the PCM wave data.

Meanwhile, according to an information providing method using recognition of an external sound source by a mobile communication terminal, the information providing method in which the mobile communication terminal recognizes a specific sound source in the external environment, detects intrinsic information from sound source information and displays the contents contained in the intrinsic information on a screen to inform an user of the intrinsic information, includes the steps of (S10) inserting the intrinsic information into sound source data and converting it to an audio file format thereby to generate a sound source file containing the intrinsic information; (S20) the mobile communication terminal receiving the sound source in the external environment by playing the sound source file and recognizing the sound source information; (S30) detecting the intrinsic information from the sound source information; (S40) decoding the intrinsic information to interpret the intrinsic information; and (S50) outputting the contents of the intrinsic information on the screen to display the intrinsic information to the user.

### DESCRIPTION OF DRAWINGS

These and other features, aspects, and advantages of preferred embodiments of the present invention will be more fully described in the following detailed description, taken accompanying drawings. In the drawings:

FIGS. 1 to 3 are conceptual views of an information providing service of a mobile communication terminal in accordance with an exemplary embodiment of the present invention.

FIG. 4 is a functional block diagram schematically illustrating an information providing system in accordance with an exemplary embodiment of the present invention.

FIG. 5 is a whole flowchart of an information providing method in accordance with an exemplary embodiment of the present invention.

FIG. 6 is a detailed flowchart of an external sound source recognizing process in accordance with an exemplary embodiment of the present invention.

FIG. 7 is an example view of a screen of the mobile communication terminal outputting intrinsic information containing URL (uniform resource locator) address in accordance with an exemplary embodiment of the present invention.

### BEST MODE

Hereinafter, preferred embodiments of the present invention will be described in detail with reference to the accompanying drawings.

1. System Configuration

FIGS. 1 to 3 are conceptual views of an information providing service of a mobile communication terminal in accordance with an exemplary embodiment of the present invention.

FIG. 1 illustrates the concept of the information providing service of the present invention, and the information providing service is based on a mobile communication terminal 2. The mobile communication terminal 2 receives a sound source played in the external environment, detects intrinsic information from sound source information recognized through receipt, and displays the intrinsic information on a screen thereby to provide a user with the intrinsic information. Assuming that the intrinsic information displayed on the screen is a specific URL address, the user makes a wireless connection to a corresponding web server 4 and is provided with specific contents. The web server 4 may be replaced with a WAP server.

The mobile communication terminal 2 of the present invention includes mobile phones, PDAs or notebooks capable of internet connection in various communication environments such as wire or wireless Internet, Wibro or HSDPA. And, the mobile communication terminal 2 includes microphones and decoding software (for example, VM (Virtual Machine) or WIPI (Wireless Internet Platform for Interoperability)) therein for sound source analysis, and receives an external sound source and displays the detected intrinsic information on the screen to provide user with the intrinsic information.

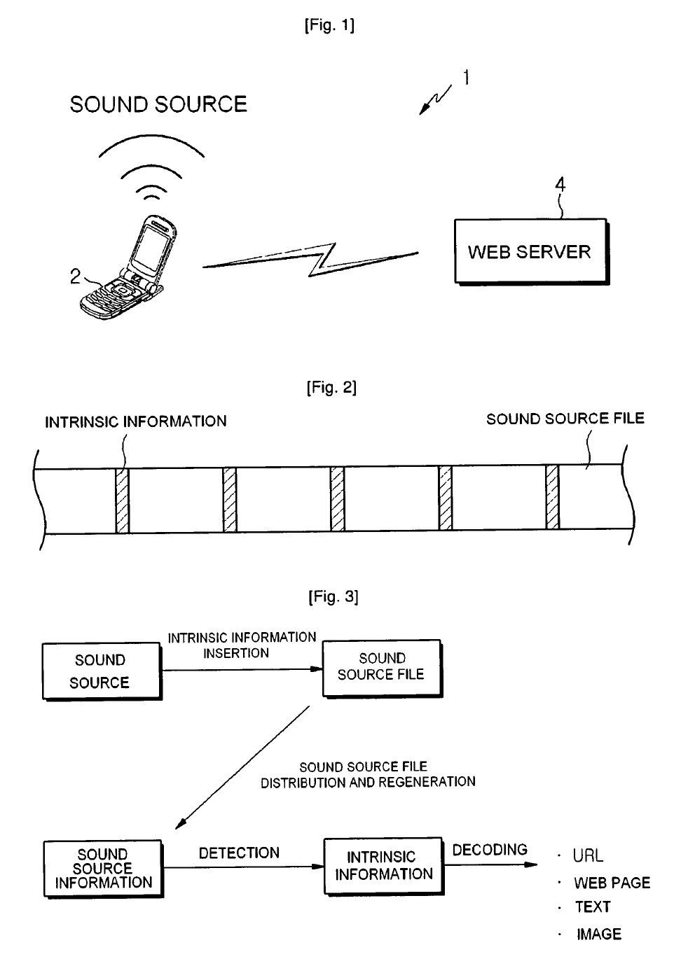

Referring to FIG. 2, a sound source file of the present invention is formed in an audio format including mp3, mpeg, ra, wma or cda, and may be not limited to a specific type. But, the intrinsic information is inserted repeatedly or periodically over the entire data area of the sound source file.

Therefore, in the case that the mobile communication terminal receives a part of the sound source by playing the sound source file, at least one intrinsic information may be included in the sound source. Such intrinsic information requires robustness of insertion in the sound source file and the efficiency of detection in the mobile communication terminal 2 so that the intrinsic information is not transformed even in case the intrinsic information is recognized together with various noises and suffered from a conversion processing of data format.

In practice, sound source blocks and intrinsic information blocks are not arranged alternately in audio data of the sound source as shown in FIG. 2, but audio data of the sound source is combined with signals of intrinsic information over the whole voice band of audio sound source, and thus audio data of the sound source is diffusely inserted to such an extent that the audio data is not distinguished by an auditory sense of human.

Referring to FIG. 3, an original pure sound source data is manufactured as a sound source file of audio format into which intrinsic information is repeatedly inserted by a service provider (or, an executor) of the present invention. The sound source file is distributed through various channels or media (for example, e-mail, a home page, a TV radio or a CD), and the sound source recognized by playing the sound source file is stored as sound source information through the mobile communication terminal 2. The mobile communication terminal 2 extracts intrinsic information from the stored sound source information and displays the interpreted contents to the user. The user checks the intrinsic information displayed in various types, for example a URL, a web page, text (e.g. a notice) or an image through a screen of the mobile communication terminal 2.

The intrinsic information is provided to the user, and in case the intrinsic information is a URL address, the user selects a confirmation button (for a wireless Internet connection), connects to a corresponding web server 4 and is provided with specific contents. For example, assume that the user listens to a specific music sounding on the streets, executes a VM program of his/her mobile phone and receives a sound source of the music. A liquid crystal display of the mobile phone displays a discount coupon code and a URL address of a disc selling site, and if the user having the corresponding coupon connects to the disc selling site and purchases a CD containing the music, the liquid crystal display informs the user of information that the CD sells at a discount. Then, the user selects a wireless Internet connection button of the mobile phone, connects to an online disc site and purchases the CD at a discount. And, it is possible to directly purchase the CD at an offline store with the discount coupon code according to the contents of intrinsic information.

As described above, the intrinsic information may be provided as data having the contents of advertising characteristic which the service provider provides to the user in the format of text or image, or the intrinsic information may be indicated in the format of a web page (for example, a bridge page mediating connection to a specific site). That is, the intrinsic information provided in the present invention may be displayed on the mobile communication terminal 2, and the intrinsic information may be not limited to a specific data format or contents.

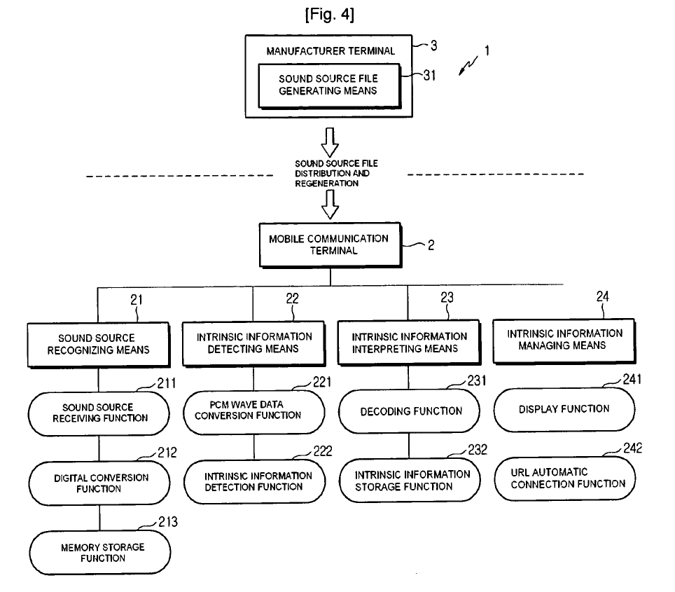

FIG. 4 is a functional block diagram schematically illustrating an information providing system 1 in accordance with an exemplary embodiment of the present invention.

The information providing system 1 according to an exemplary embodiment of the present invention includes a manufacturer terminal 3 for manufacturing the sound source file and the mobile phone terminal 2 for recognizing the sound source regenerated from the sound source file.

The manufacturer terminal 3 is managed by the service provider of the present invention and includes a sound source file generating means 31 for inserting a specific intrinsic information to be communicated to the user into PCM wave data of a sound source, converting it into an audio file format and generating a sound source file containing the intrinsic information. When such sound source file is played, the intrinsic information is properly transmitted to the user regardless of play media or transmission channel, but the user cannot distinguish the intrinsic information from the sound source by ordinary perceptivity.

The mobile communication terminal 2 according to an exemplary embodiment of the present invention includes a sound source recognizing means 21, an intrinsic information detecting means 22, an intrinsic information interpreting means 23 and an intrinsic information managing means 24.

The sound source recognizing means 21 receives an analogue sound source in the external environment by playing the sound source file containing the intrinsic information regardless of time and space by a sound source receiving function 211. The mobile communication terminal 2 has a microphone therein. Recently, a product has a directional microphone of excellent performance that is capable of receiving an external sound source with reduced noises when it is located facing the direction of an external sound source.

A digitization function 212 converts the received analogue sound source into a digital sound source using a voice codec. A memory storage function 213 stores the converted digital sound source in an internal memory as sound source information.

In this process a mobile phone generally uses EVRC or Q-CELP having a storage method through a voice codec, and audio of such a format has lower data quality than audio of a typical format such as wave or mp3. Thus, the sound source information stored in the mobile communication terminal 2 is contaminated by a mixture of an original sound source file data and the external noises, which makes it difficult to extract the inserted intrinsic information from the sound source information.

The intrinsic information detecting means 22 converts the sound source information into PCM wave data of pure sound source type through a data conversion function 221. An intrinsic information detection function 222 detects the intrinsic information from the converted PCM wave data. The functions require effective detection performance using a synchronizing process for detection of a correct information and an applicable detection value sorting method for improving the detection performance.

The intrinsic information interpreting means 23 performs a decoding function 231 to decode the detected intrinsic information and interpret the meaning of the intrinsic information. Through this process, the intrinsic information is sorted into a URL address, web page, text or image data. For meaningful information interpretation, a block format of the intrinsic information may be defined or a data identifier may be defined beforehand.

An intrinsic information storage function 232 stores the interpreted information after a decoding process in a specific folder of the internal memory so that the user can retrieve the information at any time.

A display function 241 of the intrinsic information managing means 24 outputs the contents of the interpreted intrinsic information on the screen to display the intrinsic information to the user. The user checks the intrinsic information included in the sound source through the screen. The intrinsic information may include various contents, for example tickets, coupons or gift certificates, or include a specific URL address to induce more detailed information.

Also, the information managing means 24 checks data property of the intrinsic information displayed on the screen, automatically displays the linked interface on the screen and receives the execution selection from the user. For example, in the case of an URL address, a URL automatic connection function 242 connects to a specific web server 4 or a WAB server corresponding to the URL address at a connection request of the user. Thus, the user is provided with various contents registered on the home page through wireless Internet connection and having a larger quantity of information such as product purchase, game, advertisement watching or survey. As another example, in case a music emitting from radio is received by a mobile phone and the extracted intrinsic information is a bell sound source of the music, the URL automatic connection function 242 automatically executes an internal bell sound interface program and asks the user whether to regenerate or register the bell sound.

2. Method Configuration

An information providing method using recognition of the external sound source by the mobile communication terminal 2 according to an exemplary embodiment of the present invention is embodied by constructing the above-mentioned information providing system 1. The user receives a sound source in the external environment through the mobile communication terminal 2, and if intrinsic information is detected from the sound source and displayed on the screen of the mobile communication terminal 2, the user takes an action according to the guided information.

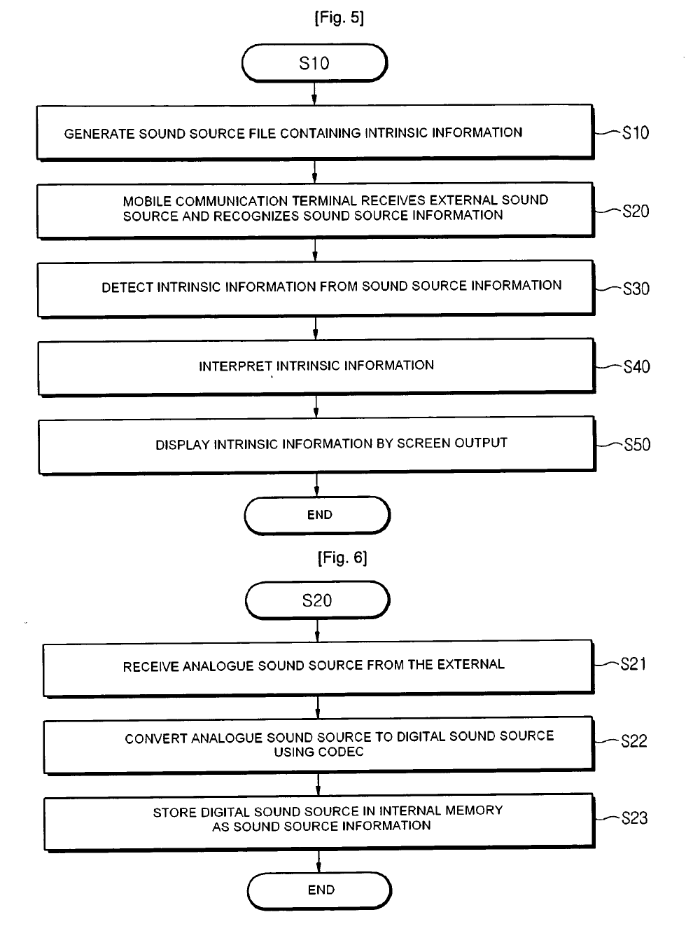

FIG. 5 is a whole flowchart of the information providing method in accordance with an exemplary embodiment of the present invention.

The service provider of the present invention inserts the intrinsic information into a pure sound source data and converts it to an audio file format (for example, mp3, mpeg, ra, wma or cda) to generate a sound source file containing the intrinsic information (S10).

The intrinsic information is communicated to the user, includes information of an image, text or a web page, and is not limited to specific format and contents if only the intrinsic information is displayed to the user through the screen of the mobile communication terminal 2. And, the intrinsic information is repeatedly inserted at a predetermined interval over the entire area of PCM wave data of the sound source, and thus the intrinsic information contained in the sound source can be detected even if only a part of the sound source is received.

The mobile communication terminal 2 recognizes the sound source by playing the distributed sound source file, as sound source information (S20).

Specifically describing the above step (S20) with reference to FIG. 6, the mobile communication terminal 2 receives an analogue sound source in the external environment by playing the sound source file having the intrinsic information inserted therein (S21). The mobile communication terminal 2 converts the received analogue sound source into a digital sound source using the voice codec (S22). And, the mobile communication terminal 2 stores the converted digital sound source in the internal memory as sound source information.

The intrinsic information is detected from the sound source information stored in the internal memory by a detector (S30). This step converts the sound source information into PCM wave data of a state before compression and detects the intrinsic information from the PCM wave data of the format of an original state. That is, a manufacturing algorithm of the sound source file is inversely executed to convert the sound source information into a source format and detect the intrinsic information from the sound source information.

The detected intrinsic information is decoded according to a proper format and interpreted to information displayable to the user (S40). The interpreted information has a format of an image, text or a web page.

After the intrinsic information is interpreted, the mobile communication terminal 2 outputs the contents of the intrinsic information on the screen to display the intrinsic information to the user (S50). If the intrinsic information displayed on the screen is an URL address, when the user selects the connection identification in the mobile communication terminal 2, the mobile communication terminal 2 makes a wireless Internet connection to an Internet site corresponding to the URL address and displays the contents of the web page on the screen. The intrinsic information includes various data, for example text information (discount coupons, lottery tickets or serial keys) or image information that the service provider intends to communicate to the user.

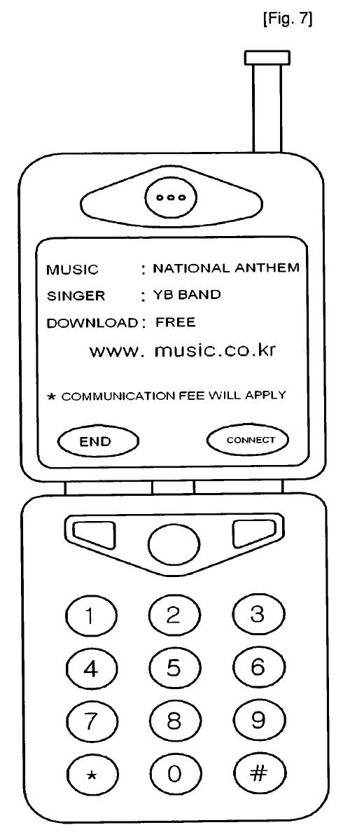

FIG. 7 is an example view of the screen of the mobile communication terminal 2 displaying the intrinsic information in case the intrinsic information is an URL address in the above step (S50).

This service shows that when the user listens to a specific music on the street and recognizes a sound source using the mobile communication terminal 2, the user is informed of the singer's name and music title and can download the sound data free of charge. A monitor screen of the mobile communication terminal 2 shows that the user can download the sound source data free of charge but should pay a communication fee, in the case that the user makes a wireless Internet connection to the indicated URL address.

Described above are the example embodiments of the information providing system and method using the external sound source of the mobile communication terminal and the mobile communication terminal according to the present invention. However, it should be understood that the detailed description and specific examples while indicating preferred embodiments of the invention, are given by way of illustration only, since various changes and modifications within the spirit and scope of the invention will become apparent to those skilled in the art from this detailed description.

### INDUSTRIAL APPLICABILITY

The information providing system and method according to the present invention repeatedly inserts a message that is intended to communicate to a user, into a sound source file as intrinsic information, receives the sound source by playing the sound source file through the mobile communication terminal of the user detects the intrinsic information from the sound source, and outputs the intrinsic information to the user on the screen, and thus the present invention has an effect to provide information of various contents to the user regardless of time and space.

1. An information providing system using external sound source recognition of a mobile communication terminal, in which the mobile communication terminal recognizes a specific sound source in the external environment, detects intrinsic information from sound source information and displays the contents contained in the intrinsic information on a screen to inform an user of the intrinsic information, the system comprising:
a sound source recognizing means for receiving a specific sound source in the external environment by playing a sound source file and recognizing sound source information;
an intrinsic information detecting means for detecting the intrinsic information inserted when manufacturing the sound source file from the sound source information;
an intrinsic information interpreting means for decoding the intrinsic information to interpret the meaning of the intrinsic information; and
an intrinsic information managing means for outputting the contents of the intrinsic information on the screen to display the intrinsic information to the user.

2. The information providing system of claim 1,
wherein the sound source recognizing means includes:
function for receiving an analogue sound source in the external environment by playing the sound source file having the inserted intrinsic information;
function for converting the analogue sound source into a digital sound source using a sound codec; and
function for storing the digital sound source in an internal memory as the Sound source information.

3. The information providing system of claim 1,
wherein the intrinsic information detecting means includes:
function for converting the sound source information into pulse code modulated (PCM) wave data; and
function for detecting the intrinsic information from the PCM wave data.

4. The information providing system of claim 1,
wherein the intrinsic information interpreting means includes:
function for decoding the intrinsic information to interpret the meaning of the intrinsic information; and
function for storing the interpreted intrinsic information in a specific folder of the internal memory.

5. The information providing system of claim 1,
wherein the intrinsic information managing means includes:
function for outputting the contents of the intrinsic information on the screen to display the intrinsic information to the user; and
function for automatically executing a linked interface program (including wireless Internet connection) according to data property (including a URL (Uniform Resource Locator) address) of the intrinsic information.

6. The information providing system of claim 1, further comprising:
a sound source file generating means for inserting the intrinsic information into the PCM wave data of the sound source and converting into an audio file format to generate the sound source file containing the intrinsic information.

7. The information providing system of claim 1 or 6,
wherein the intrinsic information includes information of an image, text or a web page.

8. The information providing system of claim 1 or 6,
wherein the sound source file has the intrinsic information inserted repeatedly over the entire area of sound source data at a predetermined interval so that the intrinsic information is detected from a part of the sound source during playing the sound source.

9. The information providing system of claim 1 or 6,
wherein the sound source file is an audio file including mp3, mpeg, ra, wma, or cda.

10. An information providing method using external sound source recognition of a mobile communication terminal, in which the mobile communication terminal recognizes a specific sound source in the external environment, detects intrinsic information from sound source information and displays the contents contained in the intrinsic information on a screen to inform an user of the intrinsic information, the method comprising the steps of:
(S10) inserting the intrinsic information into sound source data and converting into an audio file format to generate a sound source file containing the intrinsic information;
(S20) the mobile communication terminal receiving the sound source in external environment by playing the sound source file to recognize the sound source information;
(S30) detecting the intrinsic information from the sound source information;
(S40) decoding the intrinsic information to interpret the intrinsic information; and
(S50) outputting the contents of the intrinsic information on the screen to display the intrinsic information to the user.

11. The information providing method of claim 10,
wherein the step (S10) includes repeatedly inserting the intrinsic information including information of image, text or a web page over the entire area of PCM wave data of the sound source at a predetermined interval and converting into an audio file format to generate the sound source file containing the intrinsic information.

12. The information providing method of claim 10,
wherein the step (S20) includes the steps of:
(S21) the mobile communication terminal receiving an analogue sound source in the external environment by playing the sound source file having the inserted intrinsic information;
(S22) converting the analogue sound source into a digital sound source using a sound codec; and
(S23) storing the digital sound source in an internal memory as the sound source information.

13. The information providing method of claim 10,
wherein the step (S30) converts the sound source information into the PCM wave data and detects the intrinsic information from the PCM wave data.

14. The information providing method of claim 10,
wherein the step (S40) interprets information of an image, text or a web page from the intrinsic information.

15. The information providing method of claim 10,
wherein the step (S50) further includes, in the case that the intrinsic information displayed on the screen is an URL address, making a wireless internet connection to an Internet site corresponding to the URL address by authorization of the user.

16. A mobile communication terminal for recognizing a specific sound source in the external environment, detecting intrinsic information from sound source information and displaying the contents contained in the intrinsic information on a screen to provide an user with the intrinsic information, the mobile communication terminal having a VM (virtual machine) program mounted therein for providing the intrinsic information using sound source recognition, the VM program comprising the steps of:
(S10) inserting the intrinsic information into sound source data and converting into an audio file format to generate a sound source file containing the intrinsic information;
(S20) the mobile communication terminal receiving the sound source in the external environment by playing the sound source file and recognizing sound source information;
(S30) detecting the intrinsic information from the sound source information;
(S40) decoding the intrinsic information to interpret the meaning of the intrinsic information; and
(S50) outputting the contents of the intrinsic information on the screen to display the intrinsic information to the user.
